(19) United States
(12) Patent Application Publication
(10) Pub. No.: US 2013/0186038 A1
(43) Pub. Date: Jul. 25, 2013

(54) FOLDING CLOSURE

(71) Applicant: Craig Cameron Lang, Eltham (AU)

(72) Inventor: Craig Cameron Lang, Eltham (AU)

(73) Assignee: MAMMOTH INDUSTRIES PTY LTD., Thomastown, Vic (AU)

(21) Appl. No.: 13/814,198

(22) PCT Filed: Aug. 5, 2011
(86) PCT No.: PCT/AU11/00994

§ 371 Date: Apr. 9, 2013

(30) Foreign Application Priority Data
Aug. 5, 2010 (AU) 2010903490

(51) Int. Cl. E05D 15/26

(52) U.S. Cl. CPC E05D 15/26
USPC 52/745.16; 160/199

(57) ABSTRACT

The invention relates to a folding closure system for an opening comprising; an overhead track, a jamb panel attached to the head and sill of the opening by at least one (non-offset) pivot hinge, at least one other panel of substantially equal width to the jamb panel and which is suspended from the track by at least one carriage, the aforementioned panels being adapted to be folded about (non-offset) pivot hinges from (i) a closed configuration in which the panels are aligned in a plane, to (ii) an open configuration in which they are arranged orthogonal to said plane, and at least one jamb trim attached to a jamb and aligned with a gap between the jamb panel and the jamb when the panels are in the closed configuration.

### FIELD OF INVENTION

The present invention relates to the field of folding closures including folding doors or window.

In one form, the invention relates to a folding closure comprising two or more panels of equal, or substantially similar width.

In one particular aspect the present invention is suitable for use as a folding door having a plurality of panels of the same or similar width and a smooth opening and closing action.

It will be convenient to hereinafter describe the invention in relation to folding doors, however it should be appreciated that the present invention is not limited to that use and can be applied to other folding closures including windows and partitions.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Folding closures are well known and widely used in the construction industry for industrial, commercial and domestic premises for closing off an opening In an interior or exterior wall. Folding closures typically include at least two hinged panels that are suspended from one or more carriages that travel along an overhead track. The closures may also be supported at their base by carriages on a floor-level track. The panels are adapted to be folded about their hinged connections from (i) a closed configuration in which the panels are aligned with the plane of an opening, to (ii) an open configuration in which they are in a substantially parallel arrangement and orthogonal to the plane of the opening.

Accordingly, when not in use, the panels may be folded into the open configuration and stored at one side of the wall opening. Very wide openings often have two sets of panels that fold to each side.

### Hinge Configurations

Hinges are key elements of door and window of closures. Most single panel doors are hung on non-offset hinges installed at the top and bottom of the panel to transfer weight to the floor. Folding closures typically include at least one pair of adjacent panels hinged together by at least one offset hinge. Specifically an offset hinge is a hinge having one or more leaves, each adapted to be fixed to respective panels, the plane of the fixing face of each leave being offset from the hinge axis.

Offset pivot hinges are particularly useful if a door panel is mounted to a jamb that is not plumb, because the pivot can be horizontally adjusted to permit the door panel to travel properly relative to the frame.

Typically, a multi-panel folding closure is manufactured using panels of two different widths, the panels at either end of the closure (the jamb panel and the lead panel) having greater width than the intermediate panels. Specifically, to ensure that the jamb panel closes sufficiently close to the jamb (for aesthetic reasons, and to provide any necessary weatherproofing) the jamb panel is hinged adjacent the jamb, fastened to the top and bottom track in a specific position by upper and lower offset pivot hinges, each having an offset leaf. That is, the mounting face of each hinge leaf is offset from the hinge axis. Similarly, to ensure that the leading panel closes sufficiently close to the opposing jamb or an opposing leading panel, the lead panel is hinged to the carriage by an upper offset hinge having a single angled leaf.

As a result, the jamb panel and lead panel are wider than the intermediate panels by a distance equivalent to the hinge offset.

The need to have two different panel widths has the disadvantage of adding to cost of manufacture and the parts inventory for this type of closure.

Attempts have been made to overcome these disadvantages. For example U.S. Pat. No. 4,295,514 discloses a bi-fold closure having two panels of equal width, joined by hinges offset from the panel edges. This permits the panels to be opened to an obtuse angle which is suitable for a bi-fold closure. However closures having three or more panels are usually fitted to comparatively large openings which do not permit panels to open to an obtuse angle. Furthermore the invention of U.S. Pat. No. 4,295,514 would not permit three or more panels of a closure to be arranged parallel to each other and perpendicular to the plane of the opening. If the jamb panel is folded perpendicular to the plane of the opening, the adjacent intermediate panel will be angled obliquely, taking up more space in the opening and detracting from the aesthetic appearance of the folded panels. It is also designed for bi-fold doors having pivots and guides within the perimeter or plan section of the closure, unlike many suspended multi-panel folding closures in which the hinge axis of each panel is located outside the plan section of the panel.

Australian innovation patent 2005101027 discloses a folding closure having at least three hinged upright panels of substantially equal width. However this closure is limited to the use of at least one double leaf offset hinge to connect the jamb panel to the intermediate panel. One of the disadvantages of this system is the need for increased inventory of hinges. Another disadvantage is that the fit between the jamb and jamb panel leads to scuffing and excessive wear of any seal applied to the sill and head of the door frame for weatherproofing or sound proofing.

### SUMMARY OF INVENTION

An object of the present invention is to provide a folding closure having at least some multiple panels of equal width and reduced inventory compare with equivalent closures of the prior art. Typically the majority of panels will be of equal width, but some closures may include at least one wider panel.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a folding closure system for an opening comprising:

an overhead track,

a jamb panel attached to the head and sill of the opening by at least one (non-offset) pivot hinge,

at least one other panel of substantially equal width to the jamb panel and which is suspended from the track by at least one carriage, the aforementioned panels being adapted to be folded about (non-offset) pivot hinges from (i) a closed configuration in which the panels are aligned in a plane, to (ii) an open configuration in which they are arranged orthogonal to said plane, and

at least one jamb trim attached to a jamb and aligned with a gap between the jamb panel and the jamb when the panels are in the closed configuration.

Typically the opening will be defined by a frame, the jamb, sill and head comprising part of the frame.

The term ‘orthogonal to said plane’ is intended to include panels that are not exactly orthogonal, and is meant to include an angle from which the panels can be moved to a closed position. Thus an angle of between about 80 and 120° would fall within the term. The term ‘aligned in a plane’ is intended to include panels that are substantially side by side and at an angle from which the panels can be moved to the open or retracted position.

Preferably, the folding closure system includes between two and five panels of substantially equal width. In some embodiments of the present invention, the closure system additionally includes a leading panel that is not of substantially equal width with the jamb panel.

The non-offset pivot hinges may be any standard, readily available fitting of this type that is suitable for folding closures. This type of hinge can be made from comparatively thick plate metal or extruded or cast metal, up to at least 4 mm thickness, which is strong and durable. Non-offset hinges may be fitted at both the top and the bottom of the jamb panel.

The use of a non-offset pivot hinge typically creates a gap of about 5 to 15 mm between a jamb and jamb panel, which is hidden from view by the aligned jamb trim. Usually a jamb trim will be applied to both jambs of an opening to create a symmetric and aesthetic finish.

A seal, such as a rubber or foam strip may be provided on the interior surface of the jamb trim to cover the gap and provide sound proofing, draft proofing or weather proofing. Offset hinges on prior art closures tend to exhibit scuffing on the weather seals that form part of the head and sill of the frame.

The folding closure system of the present invention is typically used as a door or window for an opening in a structure such as a wall. For smaller openings, typically a single closure system will be sufficient. Larger openings will typically have two closure systems which converge from opposite directions along the track. In one preferred embodiment, both closure systems are constructed according to the present invention. Alternatively, one of the closure systems is constructed according to the present invention and the other closure system is of a construction known in the prior art.

In another aspect of embodiments described herein there is provided a method of installing a folding closure system in an opening comprising:

attaching a jamb panel at a head and sill of the opening by at least one (non-offset) pivot hinge,

suspending at least one other panel of substantially equal width to the jamb panel from an overhead track by at least one carriage, said panels being adapted to be folded about hinges from (i) a closed configuration in which the panels are aligned in a plane, to (ii) an open configuration in which they are arranged orthogonal to the plane, and

attaching at least one jamb trim to a jamb, such that the jamb trim is aligned with a gap between the jamb panel and the jamb when the panels are in the closed configuration.

Other aspects and preferred forms are disclosed in the specification and/or defined in the appended claims, forming a part of the description of the invention.

In essence, embodiments of the present invention stem from the realization that it is possible to provide a closure having panels of substantially equal width using a standard, non-offset pivot hinge.

Advantages provided by the present invention comprise the following:
The ability to use standard (non-offset) hinges and a single width of door panel thus reducing inventory and simplifying installation and assembly of the closure,
Ability to use thicker hinge plates associated with standard hinges which provide increased strength and greater durability,
Level sighting of the closure when in the open position thus improving the aesthetics of the closure,
Neat finishing provided by jamb trim to improved the aesthetics of the closure,

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a plan view of a typical folding closure of the prior art;

FIG. 2 illustrates another folding closure of the prior art as described in Australian innovation patent 2005101027;

FIG. 3 illustrates a perspective view of the folding closure of FIG. 2;

FIG. 4 illustrates a folding closure according to the present invention in an end-on top view (FIG. 4(a)) a perspective view in an open configuration (FIG. 4(b)) and a perspective view between the open and closed configurations (FIG. 4(c));

FIG. 5 illustrates various hinged folding panels suitable for closing an opening which include the folding closure of the present invention alone or in combination with folding closures of the prior art; and

FIG. 6 illustrates various arrangements of hinged folding panels according to the present invention and suitable for closing an opening.

### DETAILED DESCRIPTION

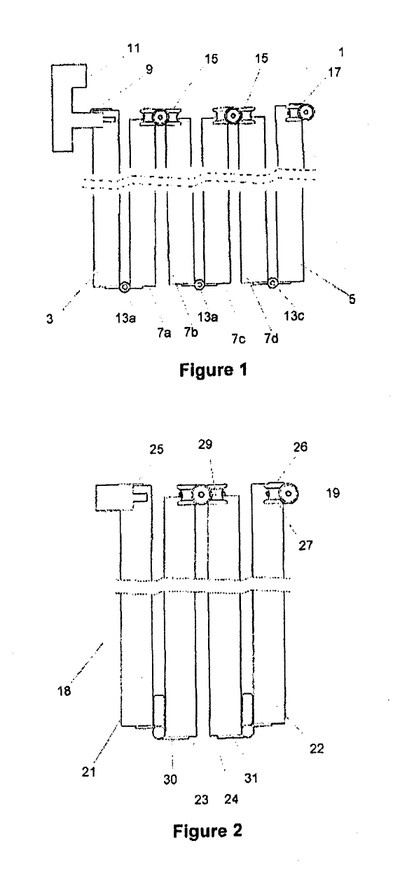

FIG. 1 is a plan view of a typical folding closure (1) of the prior art. The closure (1) illustrated includes a jamb panel (3) attached to the head and sill of a frame, adjacent the jamb (11) of the frame by a single leaf hinge (9). The closure includes a further five panels, including a leading panel (5) and intermediate panels (7a,7b,7c,7d) which are all of substantially the same width. The intermediate panels are hinged to panels on either side by edge fixed lower butt hinges (13a,13b,13c) and upper butt hinges (not shown). The upper butt hinges are suspended from a carriage (15) that interconnects with an overhead track (not shown). The end of the leading panel (5) is suspended from the track by a single leaf carrier hinge (17) comprising a combination of a carriage and a hinge.

FIG. 2 is a plan view of another folding closure (18) of the prior art as described in Australian innovation patent 2005101027.

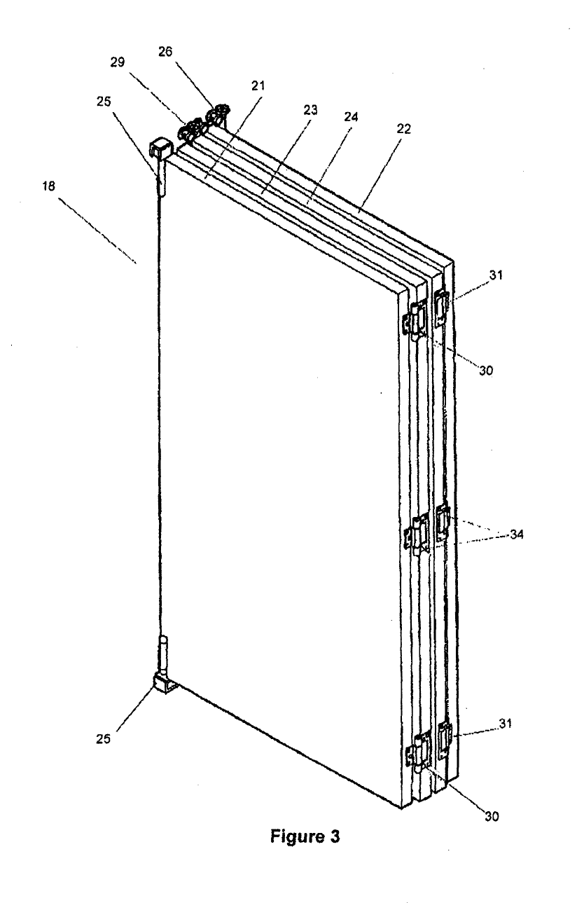

FIG. 3 depicts the same closure (18) as FIG. 2 in perspective view. This folding closure (18) includes a jamb panel (21) hinged to a jamb (not shown) by top and bottom single leaf offset hinges (25). The lead panel (22) is suspended from a carriage (27) by a single leaf offset hinge (26). The axes of the hinges (25,26) are aligned with the centreline of the track (19) on which the carriages (26,29) travel. The carriages (26,29) can therefore form part of respective carrier hinges. Intermediate panel (23) is hinged to the jamb panel (21) by top and bottom double leaf offset hinges (30). Similarly, at its other end, intermediate panel (24) is hinged to the lead panel (22) by top and bottom double leaf offset hinges (31)

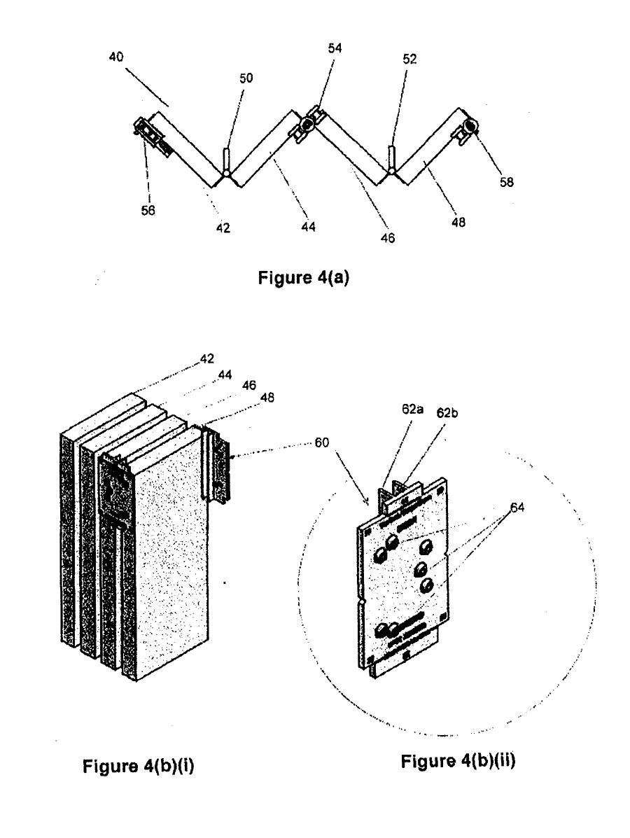

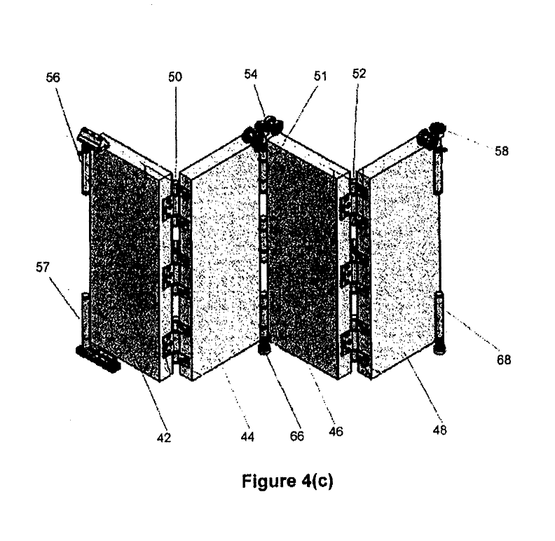

FIG. 4 illustrates a folding closure (40) according to the present invention. FIG. 4(a) shows an end-on view of the top of the closure (4) which includes four panels—a jamb panel (42), two intermediate panels (44,46) and a lead panel (48). The jamb panel (42) and lead panel (48) are connected to their respective adjacent intermediate panel (44,46) by standard (non-offset) pivot hinges (50,52). The non-offset pivot hinge connecting the intermediate panels (44,46) are not visible in this view, being obscured by the four wheel carriage (54) which in use moves along an overhead track. The jamb panel (42) is connected to a jamb by the standard top pivot (56) and a standard bottom pivot (not visible in this view). The leading edge of the lead panel (48) includes a two wheel carriage (58) which in use moves along the overhead track.

FIG. 4(b) (i) is a perspective view of the folding closure of FIG. 4(a) in an open configuration without fittings. In this view it can be seen that the panels are the same width, and their edges are neatly aligned, in contrast to the folding closure of the prior art depicted in FIG. 3. This view also depicts a drilling jig (60) that can conveniently be used for hinge and pilot hole location. The drilling jig includes spacers (62a,62b) that fit between adjacent edges of the panels and allow sufficient gap for fitting of the shaft of the non-offset pivot hinge, and multiple pilot holes (64) to act as a guide for drilling holes for screw fitting of the pivot hinge. The drilling jig (60) is enlarged in FIG. 4(b) (ii) to show detail.

FIG. 4(c) Is a perspective view of the folding closure of FIG. 4(a) between the open and closed configurations. In this view the four panels (42,44,46,48) can be clearly seen. Each panel is connected to the adjacent panel(s) by non-offset hinges (50,51,52). Typically at least three non-offset hinges will be required to connect adjacent panel edges, although more or less may be used depending on the size and weight of each panel. The panels move along an overhead track (not shown) by the wheel carriages (54,58). In this view the top pivot (56) and bottom pivot (57) on jamb panel (42) can be clearly seen. The guide (66) between the intermediate panels (44,46) and the guide (68) at the lower corner of the lead panel (48) can also be seen.

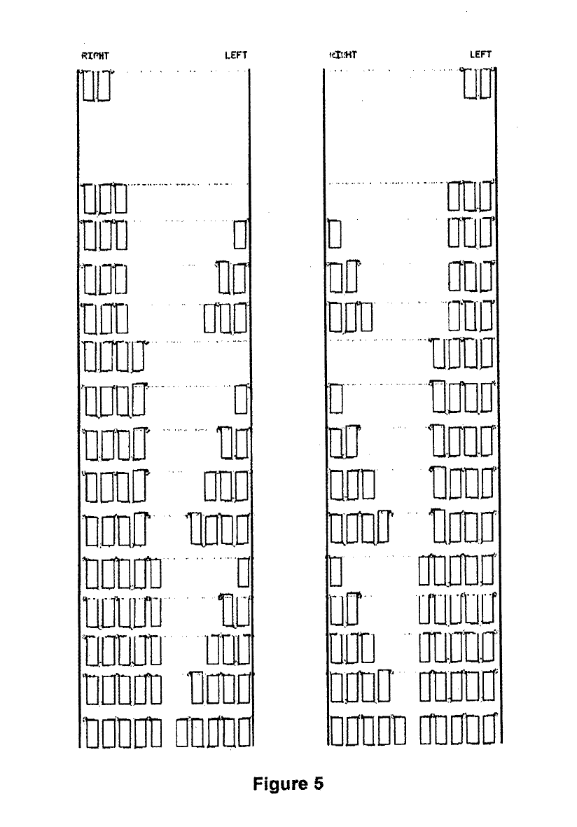

FIG. 5 illustrates various hinged folding panels suitable for closing an opening which include the folding closure of the present invention alone or in combination with folding closures of the prior art. For smaller openings, typically a single closure system will be sufficient. Larger openings will typically have two closure systems which converge from opposite directions along the track. In one preferred embodiment, both closure systems are constructed according to the present invention. Alternatively, one of the closure systems is constructed according to the present invention and the other closure system is of a construction known in the prior art. FIG. 5 depicts some typical combinations of closure systems having different numbers of panels.

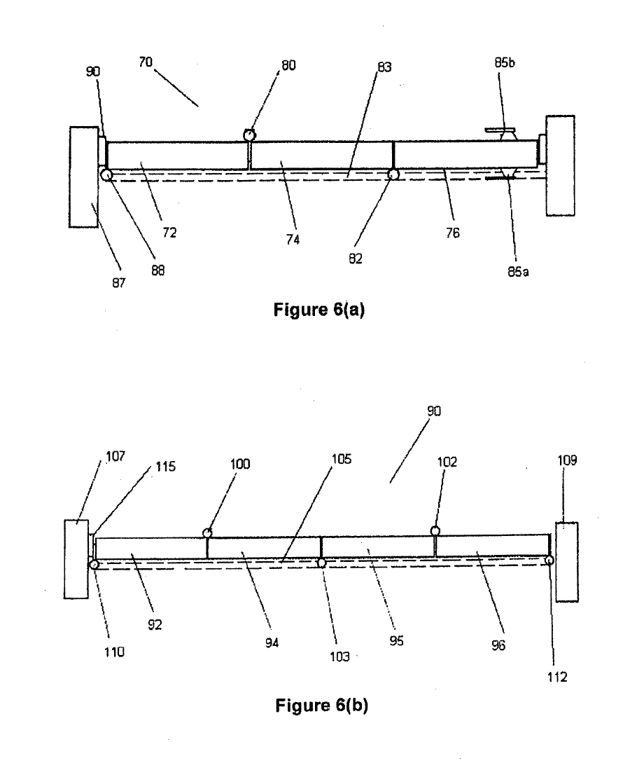

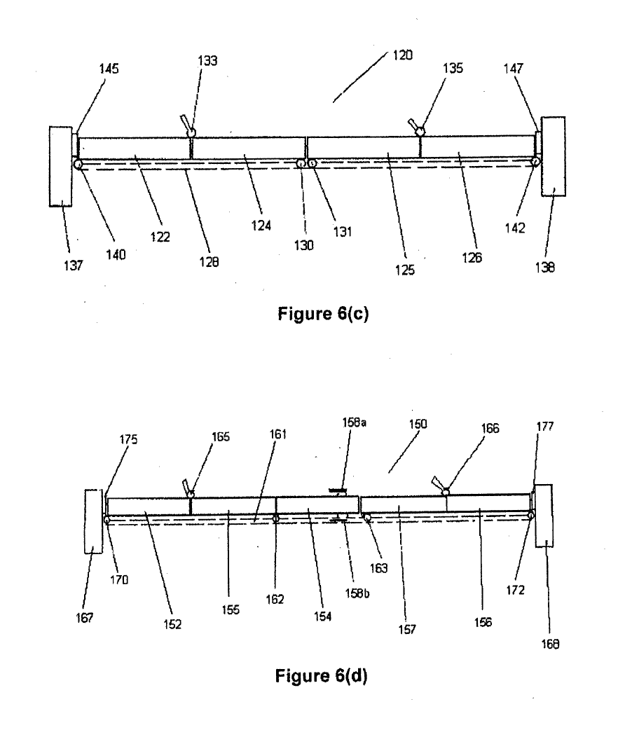

FIG. 6 illustrates panels of folding closures according to the present invention. FIG. 6(a) shows an end-on view of the top of the closure (70) which includes three panels of equal width—a jamb panel (72), an intermediate panel (74) and a lead panel (76). The jamb panel (72) and lead panel (76) are connected to the intermediate panel (74) by standard (non-offset) pivot hinges (80,82). In this view an upper track (83) is shown by the broken lines. A handle (85a, 85b) on the lead panel (76) can also be seen and is used to draw the closure (70) back and forth and to swing the lead panel (76) about pivot hinge (82) to provide access to either side of the closure. Pivot hinge (82) also acts as a guide along the track (83). The jamb panel (72) is connected to a jamb (87) by the standard top pivot (88). A jamb trim (90) attached to the jamb (87) is aligned with the gap between the jamb panel (72) and the jamb (87) when the panels are in the closed configuration.

FIG. 6(b) shows an end-on view of the top of a closure (90) which includes four panels of equal width—a jamb panels (92), a lead panel (96) and two intermediate panels (94,95) which opens to the left of the drawing. The jamb panel (92) is connected to the adjacent intermediate panel (94) by standard (non-offset) pivot hinges (100). The intermediate panels (94,95) are connected by a non-offset pivot hinge and intermediate trolley (103) which moves along a track 105. The lead panel (96) is connected to its adjacent intermediate panel (95) by a standard (non-offset) pivot hinge and includes a top-roller (112) at its lead edge for moving along a top track (105). The jamb panel (92) is connected to the jamb (107) by a standard top pivot (110) inserted inside the top track and the bottom pivot mounted inside the bottom track (not shown). Jamb trim (115) attached to the jamb (107) is aligned with the gap between the jamb panel (92) and the jamb (107) when the closure is in the closed configuration.

FIG. 6(c) shows an end-on view of the top of a closure (120) which is in two halves—one opening to the left of the drawing and the other opening to the right of the drawing. The closure includes four panels—two jamb panels (122,126) of equal width, and two lead panels (124,125) which are approximately 12 mm wider than the jamb panels (122,126). In this view a top track (128) can also be seen. Top-rollers (130, 131) on each of the lead panels (124, 125) can be used to draw the two halves of the closure (120) back and forth along an upper track (128). The jamb panels (122,126) are connected to their respective adjacent lead panels (124,125) by standard (non-offset) pivot hinges (133,135) having handles. The jamb panels (122,126) are connected to their respective jambs (137,138) by standard top pivots (140,142). Jamb trims (145, 147) attached to their respective jambs (137,138) are aligned with the gaps between the jamb panels (122,126) and the jambs (137,138) when the panels are in the closed configuration.

FIG. 6(d) shows an end-on view of the top of a closure (150) which is in two parts—one comprising three panels opening to the left of the drawing and the other comprising two panels opening to the right of the drawing. The closure includes—two jamb panels (152,156), a left lead panel (154) and an intermediate panel (155) which are all of the same width. The right lead panel (157) is about 12 mm wider than the other panels. A handle (158a, 158b) on the left lead panel (157) can also be seen and is used to draw the closure (150) back and forth and to swing the lead panel (157) open and closed to provide access to either side of the closure. In this view a top track (161) can also be seen. Top-rollers (162,163) on the lead panels (157,154) can be used to draw the two parts of the closure (150) back and forth along the upper track (161). The jamb panels (152,156) are connected to their respective adjacent panels (155,157) by standard (non-offset) pivot hinges (165,166).with or without handles. The jamb panels (152,156) are connected to their respective jambs (167,168) by standard top pivots (170,172). Jamb trims (175, 177) attached to their respective jambs (175,177) are aligned with the gaps between the jamb panels (152,156) and the jambs (175,177) when the panels are in the closed configuration.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A folding closure system for an opening comprising;
an overhead track,
a jamb panel attached to the head and sill of the opening by at least one (non-offset) pivot hinge,
at least one other panel of substantially equal width to the jamb panel and which is suspended from the track by at least one carriage, the aforementioned panels being adapted to be folded about (non-offset) pivot hinges from (i) a closed configuration in which the panels are aligned in a plane, to (ii) an open configuration in which they are arranged orthogonal to said plane, and
at least one jamb trim attached to a jamb and aligned with a gap between the jamb panel and the jamb when the panels are in the closed configuration.

2. A folding closure system according to claim 1 wherein the jamb, sill and head comprise part of a frame for an opening in a structure.

3. A folding closure system according to claim 1 comprising between two and five panels of substantially equal width.

4. A folding closure system according to claim 1 wherein the jamb trim further comprises a seal.

5. A folding closure suitable for use in the folding closure of claim 1.

6. A folding closure system according to claim 1 when used in conjunction with a second folding closure system.

7. A method of installing a folding closure system in an opening comprising:
attaching a jamb panel at a head and sill of the opening by at least one (non-offset) pivot hinge,
suspending at least one other panel of substantially equal width to the jamb panel from an overhead track by at least one carriage, said panels being adapted to be folded about hinges from (i) a closed configuration in which the panels are aligned in a plane, to (ii) an open configuration in which they are arranged orthogonal to the plane, and
attaching at least one jamb trim to a jamb, such that the jamb trim is aligned with a gap between the jamb panel and the jamb when the panels are in the closed configuration.

8. A closure system according to claim 1 and substantially as herein described with reference to any one of FIGS. 4, 5 and 6.
